(19) United States
(12) Patent Application Publication
(10) Pub. No.: US 2010/0129139 A1
(43) Pub. Date: May 27, 2010

(54) Joining Member and Joining Structure

(75) Inventors: Tatsuya Suzuki, Tokyo (JP); Masakatsu Mitsuishi, Tokyo (JP)

Correspondence Address: HOGAN & HARTSON L.L.P., 1999 AVENUE OF THE STARS, SUITE 1400, LOS ANGELES, CA, 90067, US

(73) Assignee: OLYMPUS CORPORATION, Tokyo (JP)

(21) Appl. No.: 11/573,446

(22) PCT Filed: Aug. 7, 2006
(86) PCT No.: PCT/JP06/15976

§ 371 Date: Feb. 8, 2007

(30) Foreign Application Priority Data
Aug. 8, 2005 (JP) 2005-229842
Sep. 8, 2005 (JP) 2005-261212

(51) Int. Cl. F16B 11/00; F16B 1/00

(52) U.S. Cl. 403/24; 403/380; 403/381

(57) ABSTRACT

There is provided a joining member to which wooden pieces can be attached and from which they can be detached, and a joining structure including the joining member without causing deterioration in an appearance of the wooden pieces. The joining member is placed between the plural wooden pieces (2, 3) and includes a frame (4a) and a connector (4b). The frame (4a) abuts an end face (2d, 3d) of each of the plural wooden pieces (2, 3) to fix the plural wooden pieces (2, 3). The connector (4b) is detachably attached to the frame (4a) to connect at least two wooden pieces (2, 3) among the plural wooden pieces (2, 3).

### TECHNICAL FIELD

The present invention relates to a joining member which joins plural wooden pieces, and a joining structure which is formed by such a joining member.

This application is based upon and claims the benefit of priority from Japanese Patent Applications No. 2005-229842, filed Aug. 8, 2005; and No. 2005-261212, filed Sep. 8, 2005, the entire contents of which are incorporated herein by reference.

### BACKGROUND ART

Casings that cover electronic equipments such as cameras and portable telephones are mostly made of synthetic resin or metal. Such casings are formed from plural parts which are joined with each other by screws, caulking, or the like.

Meanwhile, wood comes to attract attention as a material for jackets of electronic equipments. With a wide variety of grain patterns of wooden materials as being natural materials, wood products made of wood exhibit individual features depending on positions of the raw wood from which the particular wood products are cut out. Such individual features of each wood product give it a unique quality. In addition, surface flaws and discolorations caused by a long-term use create unique textures which tend to evoke warm and familiar feeling in the user. Thus, the wooden material attracts attention as a material for products of uniqueness and taste which cannot be found in products made of synthetic resin or light metals. Techniques for processing wooden materials are also developing dramatically.

According to one conventionally known technique for processing wooden materials: a wooden board is softened with water absorption and compressed; the compressed wooden board is cut along a direction substantially parallel with a direction in which the compressive force is applied, whereby a primary fixed product with a board-like shape is obtained; and the primary fixed product is deformed into a desired three-dimensional shape under heat and moisture (for example, see Japanese Patent No. 3078452. Publication). Further, according to another conventional technique, a softened wooden sheet is compressed and temporarily secured in a prepared mold and left in the mold until the wooden board recovers. Thus a wooden product with a desired shape can be obtained (see, for example, Japanese Patent Application Laid-Open No. H11-77619 Publication).

### DISCLOSURE OF INVENTION

When a joining member is to be fixed to a wooden piece, which is formed through compression as described above, by screwing or caulking, the wooden piece is required to have bosses, ribs, or the like so that screws or caulking members can engage therewith. It is, however, technically difficult to form the bosses or ribs which protrude from the surface of the wooden piece and to compress the formed bosses or ribs into desired shapes similarly to other portions.

In some cases, the thickness of the wooden piece to be attached and fastened with the shape retaining member has to be smaller than that of other parts. The deference in thickness, which means the difference in compression ratios, results in a deference in color tone depending on thickness. In other words, the compressed wooden piece does not have a uniform color tone, which is not preferable in terms of appearance.

In view of the foregoing, an object of the present invention is to provide a joining member and a joining structure by which a wooden piece can be readily attached and detached without deterioration in appearance of the wooden piece.

To solve the problems as described above and to achieve an object, a joining member according to one aspect of the present invention is placed between plural wooden pieces to join the plural wooden pieces, and includes a frame that abuts an end face of each of the plural wooden pieces to fix the plural wooden pieces, and a connector that is detachably attached to the frame to connect at least two wooden pieces among the plural wooden pieces.

In the joining member according to the present invention, the frame may include a main frame portion that has a contact face which abuts the end face of each of the plural wooden pieces, and a guide portion that extends in a direction substantially perpendicular to the contact face of the main frame portion to guide a moving direction of each of the plural wooden pieces when the end face of each of the plural wooden pieces is made to abut the contact face.

In the joining member according to the present invention, the connector may include a flat main plate portion, and at least two pressing protruding portions each projected in a tapered shape from one surface of the main plate portion in a direction substantially orthogonal to the one surface of the main plate portion, and the pressing protruding portions be pressed into respective surfaces of different wooden pieces among the plural wooden pieces.

In the joining member according to the present invention, the connector may be fixed to the frame by a screw.

In the joining member according to the present invention, the connector may include a screw which has a plate head and is fitted into the main frame portion, and the plural wooden pieces may be sandwiched between the guide portion and the head.

In the joining member according to the present invention, a maximum diameter of a surface of the head may be larger than a width of a portion of the main frame portion placed between different wooden pieces.

In the joining member according to the present invention, the surface of the head may be substantially perpendicular to the contact face when the screw is fitted into the main frame portion.

In the joining member according to the present invention, the guide portion may have grooves that are oriented toward a direction intersecting with a direction in which the guide portion extends from the contact face of the main frame portion on a surface which abuts one of the plural wooden pieces near a position where the screw is fitted into the main frame portion.

In the joining member according to the present invention, the guide portion may be tapered so that a thickness thereof increases as a position on the guide portion is far from the contact face of the main frame portion.

In the joining member according to the present invention, the head may have a disk shape, and may be provided with a ring flange which forms a closed ring uniform protrusion projected from an outer rim of the one surface, the one surface facing the guide portion.

In the joining member according to the present invention, a surface of the head that does not face with the guide portion and a surface of at least one of the wooden pieces sandwiched between the head and the guide portion may together form an identical plane, or a smooth curved surface.

In the joining member according to the present invention, the frame may include a protruding strip that protrudes from an edge of an inner periphery of the main frame portion in a direction substantially perpendicular to the contact face, a first protruding portion that protrudes in a tapered shape from a tip end portion of the protruding strip towards an outer periphery of the main frame portion, and a pair of second protruding portions each protruding in a tapered shape from the contact face near a proximal end of the protruding strip in a direction substantially perpendicular to the contact face and in a direction of protrusion of the protruding strip as well, and may be arranged symmetrical about a plane perpendicular to the contact face and passing through the tip end portion of the protruding strip and the apex of the first protruding portion.

In the joining member according to the present invention, the frame may include plural wooden piece anchors each of which is a combination of the protruding strip, the first protruding portion, and the pair of the second protruding portions, and the frame may be symmetrical about a plane passing through the main frame portion.

In the joining member according to the present invention, in the wooden piece anchor, an apex of the first protruding portion may be arranged at a same distance from apexes of the second protruding portions.

In the joining member according to the present invention, the main frame portion may have a closed shape.

In the joining member according to the present invention, the connector may have an attachment unit for attachment of a separate member.

In the joining member according to the present invention, the attachment unit may have a threaded hole where a screw of a tripod is fitted.

A joining structure according to another aspect of the present invention includes the plural wooden pieces and the joining member, which are of the present invention.

In the joining structure according to the present invention, the plural wooden pieces may be formed through compression.

In the joining structure according to the present invention, the plural wooden pieces each may have a closed loop end face.

In the joining structure according to the present invention, the joining member may be formed from a material with a higher strength than a material for the plural wooden pieces.

In the joining structure according to the present invention, the plural wooden pieces and the joining member may form a jacket for an electronic equipment.

In the joining member and the joining structure according to the present invention, the joining member is placed between the plural wooden pieces, and the joining member includes a frame that abuts an end face of each of the plural wooden pieces to fix the plural wooden pieces, and a connector that is detachably attached to the frame to connect at least two wooden pieces among the plural wooden pieces. Therefore, the wooden pieces can be readily attached to and detached from the joining member without deterioration in the appearance of the wooden pieces.

### BRIEF DESCRIPTION OF DRAWINGS

FIG. 1 is a perspective view of a configuration of a digital camera to which a joining member according to a first embodiment of the present invention is applied;

FIG. 2 is a bottom view of the digital camera shown in FIG. 1 viewed in the direction of arrow A of FIG. 1;

FIG. 3 is a sectional view of the digital camera taken along line B-B of FIG. 1;

FIG. 4 is a perspective view of a configuration of a front cover member of the digital camera;

FIG. 5 is a perspective view of a configuration of a rear cover member of the digital camera;

FIG. 6 is an exploded perspective view of a configuration of the joining member according to the first embodiment of the present invention;

FIG. 7 schematically shows how the cover members are joined together by the joining member according to the first embodiment of the present invention;

FIG. 8 schematically shows a process of compression of a wooden piece;

FIG. 9 is a vertical sectional view of a wooden piece during application of compressive force (where deformation of the wooden piece has nearly completed);

FIG. 10 is a partially enlarged sectional view showing the stage that a second protruding portion is being pressed into an end face of a cover member in an attachment process of a joining member to the cover member;

FIG. 11 is a partially enlarged sectional view showing the stage that a first protruding portion had been buried into an internal surface of a cover member in an attachment process of a joining member to the cover member;

FIG. 12 shows a configuration of relevant parts of a modification of the joining member according to the first embodiment of the present invention;

FIG. 13 schematically shows how the cover members are joined by the modification of the joining member according to the first embodiment of the present invention;

FIG. 14 is a perspective view of a configuration of a digital camera to which a joining member according to a second embodiment of the present invention is applied;

FIG. 15 is a bottom view of the digital camera shown in FIG. 14, viewed in the direction of arrow F of FIG. 14;

FIG. 16 is an exploded perspective view of a configuration of the joining member according to the second embodiment of the present invention;

FIG. 17 schematically shows a joining structure which joins cover members by the joining member according to the second embodiment of the present invention;

FIG. 18 is a partially enlarged view of a portion near a bottom face of the joining structure shown in FIG. 17;

FIG. 19 shows a configuration of grooves formed in a guide;

FIG. 20 schematically shows a joining structure which joins cover members by a first modification of the joining member according to the second embodiment of the present invention;

FIG. 21 schematically shows a joining structure which joins cover members by a second modification of the joining member according to the second embodiment of the present invention;

FIG. 22 schematically shows a joining structure which joins cover members by a third modification of the joining member according to the second embodiment of the present invention;

FIG. 23 is a perspective view of a configuration of a screw which is a part of the third modification of the joining member according to the second embodiment of the present invention;

FIG. 24 is an exploded perspective view of a configuration of a joining member according to a third embodiment of the present invention;

FIG. 25 schematically shows a joining structure which joins cover members by the joining member according to the third embodiment of the present invention; and

FIG. 26 shows a configuration of relevant parts of a modification of the joining member according to the third embodiment of the present invention.

### BEST MODE(S) FOR CARRYING OUT THE INVENTION

Exemplary embodiments (hereinafter simply referred to as embodiments) of the present invention will be described in detail below with reference to the accompanying drawings.

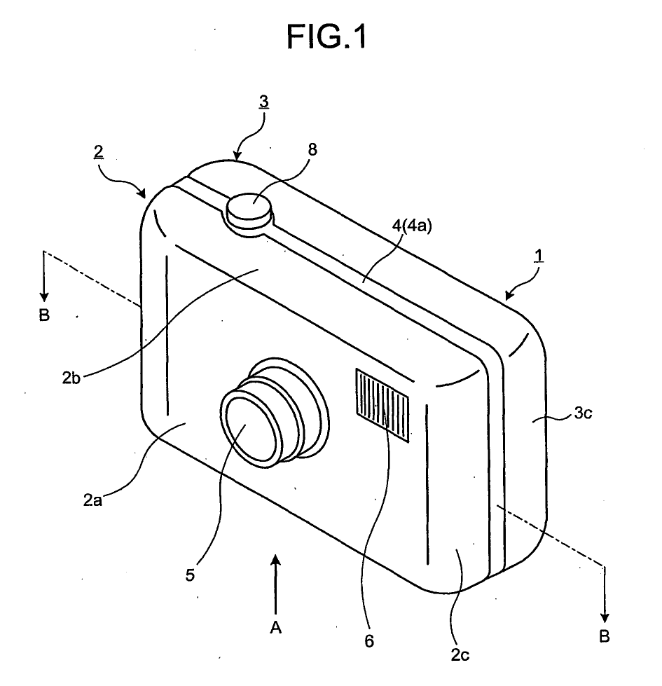

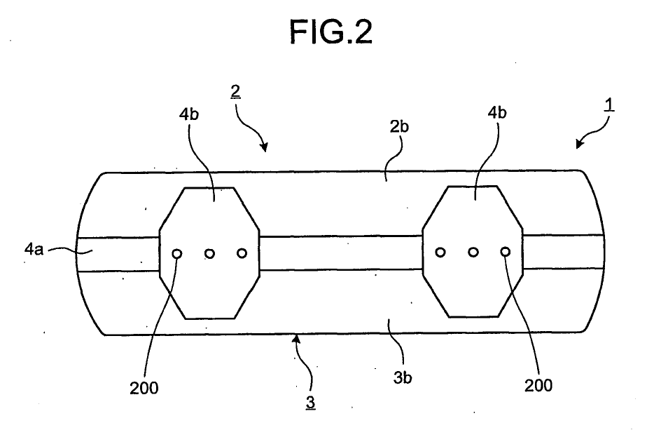

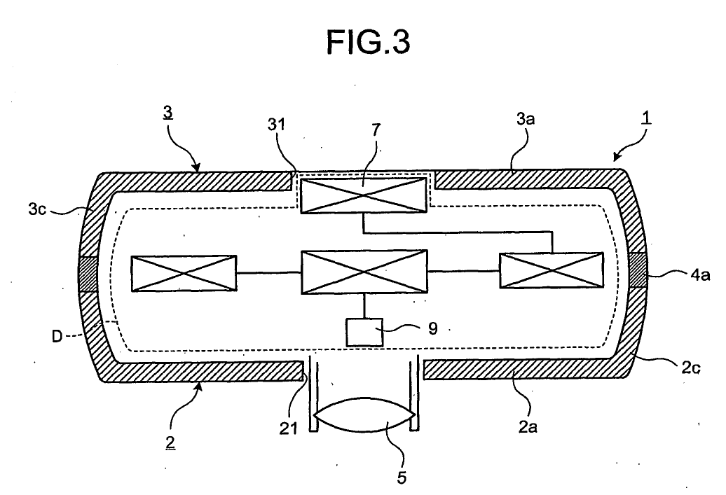

FIG. 1 shows an example of application of a joining member according to a first embodiment of the present invention. More specifically, FIG. 1 is a perspective view of a configuration of a digital camera 1 whose jacket is formed from two wooden pieces joined together by the joining member according to the first embodiment. FIG. 2 is a view (bottom view) of the digital camera viewed in the direction of arrow A of FIG. 1. FIG. 3 is a sectional view taken along line B-B of FIG. 1 and shows an internal configuration of the digital camera 1. The digital camera 1 shown in FIGS. 1 to 3 includes two cover members 2 and 3 that are substantially of the same shape, and a joining member 4 which joins two cover members 2 and 3.

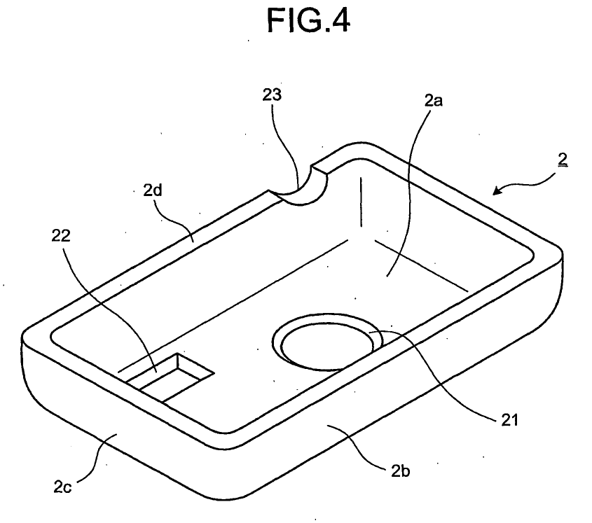

FIG. 4 is a perspective view of a configuration of the cover member 2 which covers a front portion of the digital camera 1. The cover member 2 shown in FIG. 4 includes a substantially rectangular main plate portion 2a, two side plate portions 2b that extend from two sides substantially parallel to a lengthwise direction of the main plate portion 2a making a predetermined angle to the main plate portion 2a, respectively, two side plate portions 2c that extend from another two sides substantially parallel to a breadthwise direction of the main plate portion 2a, respectively, and a closed loop end face 2d. The main plate portion 2a has a cylindrical opening 21 which exposes an image pick-up unit 5 having an imaging lens, and a cuboid opening 22 which exposes a photoflash 6. Further, a semi-cylindrical cut-out portion 23 is formed in the side plate portion 2b.

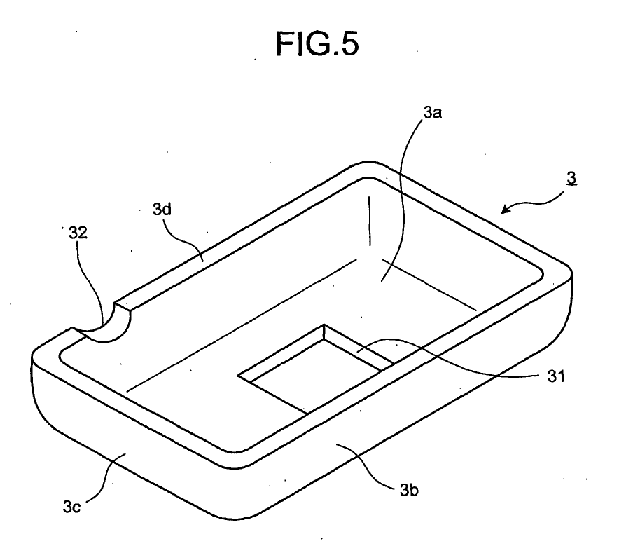

FIG. 5 is a perspective view of a configuration of the cover member 3 which covers a rear portion of the digital camera 1. The cover member 3 shown in FIG. 5 includes a substantially rectangular main plate portion 3a, two side plate portions 3b that extend from two sides substantially parallel to a lengthwise direction of the main plate portion 3a making a predetermined angle to the main plate portion 3a, respectively, two side plate portions 3c that extend from another two sides substantially parallel to a breadthwise direction of the main plate portion 3a making a predetermined angle to the main plate portion 3a, respectively, and a closed loop end face 3d. The cover member 3 is substantially of the same shape as the cover member 2.

The main plate portion 3a has a cuboid opening 31 to expose a display unit 7, which is realized by a liquid crystal display, plasma display, organic electroluminescence (EL) display, or the like, to display image information and/or text information. The side plate portion 3b has a semi-cylindrical cut-out portion 32. When the cover members 2 and 3 are joined, the cut-out portion 32 is placed opposite to the cut-out portion 23 of the cover member 2 to form an opening for exposing a shutter button 8.

Each of the cover members 2 and 3 is formed by compressing a wooden piece taken out from the uncompressed raw wood. The raw wood may be selected from various types of wood including Japanese cypress, hiba cedar, paulownia, Japanese cedar, pine, cherry, zelkova, ebony wood, bamboo, teak, mahogany, and rosewood, for example. In the drawings such as FIG. 1, the grain patterns of the cover members 2 and 3 are not shown, since the joining structure of the first embodiment can be realized irrespective of the grain patterns of the cover members 2 and 3. The manner of shaping the wooden piece, which is a raw material for the cover member 2 or 3, from the raw wood is determined depending on the conditions, such as strength and appearance required for the cover members 2 and 3. Thus the shaped wooden piece may have a straight-grain pattern, a flat-grain pattern, an intermediate grain pattern between the straight grain and the flat grain, an end-grain pattern, for example, as appropriate.

Inside the digital camera 1, various components are housed, such as the display unit 7, an imaging element 9 such as a Charge Coupled Device (CCD) or a Complementary Metal Oxide Semiconductor (CMOS), a circuit having a Central Processing Unit (CPU) to perform drive control related to the imaging process or the like and various operations, a driving circuit that drives respective functional units under the control of the control circuit, and the like. FIG. 3 schematically shows various functional units having electronic or optical functions as described above in region D (surrounded by a broken line) inside the digital camera 1.

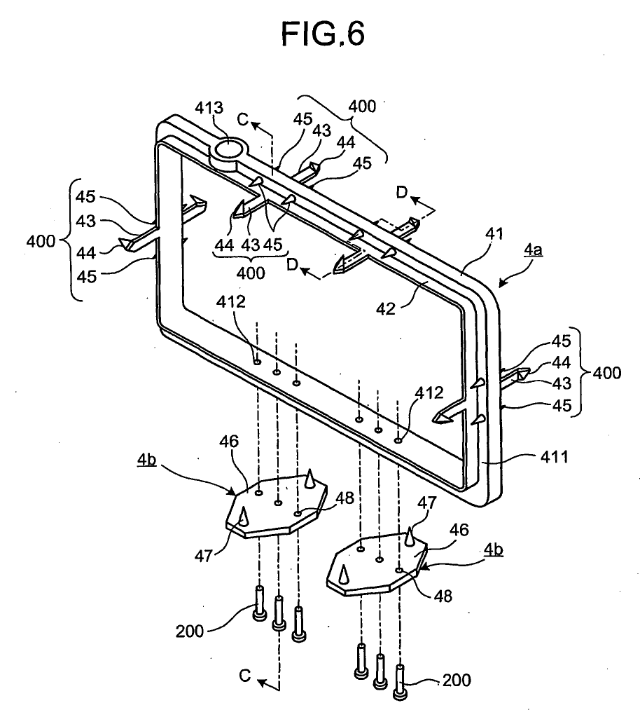

FIG. 6 shows a detailed configuration of the joining member 4. The joining member 4 of FIG. 6 is placed between the cover members 2 and 3 to join the cover members 2 and 3. Specifically, the joining member 4 includes a frame 4a and a connector 4b. The frame 4a abuts each of the end face 2d of the cover member 2 and the end face 3d of the cover member 3 to fix the cover members 2 and 3. The connector 4b is arranged at bottom faces of the cover members 2 and 3 and fixed to the frame 4a, thereby connecting the side plate portion 2b of the cover member 2 and the side plate portion 3b of the cover member 3.

The frame 4a has a main frame portion 41 and a guide portion 42. The main frame portion 41 has a contact face 411 that abuts the end face 2d of the cover member 2 and the end face 3d of the cover member 3 and has a closed shape. The guide portion 42 extends from an inner peripheral edge of the main frame portion 41 in a direction substantially perpendicular to the contact face 411 of the main frame portion 41, and serves to guide the cover members 2 and 3 along the frame 4a at the attachment thereto. Further, the frame 4a has a protruding strip 43 that protrudes from an edge of the guide portion 42 in a direction perpendicular to the contact face 411 of the main frame portion 41, a trigonal pyramidal protruding portion 44 (first protruding portion) that protrudes from a tip end portion of the protruding strip 43 towards an outer periphery of the main frame portion 41, and two circular conic protruding portions 45 (second protruding portions) each of which is provided near a proximal end of the protruding strip 43, and protrudes from the contact face 411 in the direction of protrusion of the guide portion 42. Two protruding portions 45 are arranged symmetrical about a plane perpendicular to the contact face 411 and passing through the tip end portion of the protruding strip 43 and the apex of the protruding portion 44. Two protruding portions 45 are arranged as a pair.

The protruding strip 43, the protruding portion 44, and a pair of protruding portions 45 each having an above configuration constitute a wooden piece anchor 400 in combination. The wooden piece anchors 400 are plurally provided on each contact face 411 of the frame 4a. As shown in FIG. 6, the main frame portion 41 is of a substantially rectangular shape, and has two long sides and two short sides. Each contact face 411 of the main frame portion 41 includes two sets of wooden piece anchors 400 on the upper long side (a side on which the shutter button 8 is exposed), and one wooden piece anchor 400 on each opposite position of two short sides. In brief, each contact face 411 has four wooden piece anchors 400. Since the main frame portion 41 has two contact faces 411, one facing the front side and another facing the rear side, the frame 4a includes eight wooden piece anchors 400 in total.

On an upper side of the main frame portion 41, a cylindrical hollow opening 413 is formed at a position corresponding to the cut-out portions of the respective cover members so as to expose the shutter button 8. On a lower side of the main frame portion 41, holes 412 are formed so that the connector 4b can be fixed to the frame 4a by fitting screws through the holes 412. An inner wall of the hole 412 is threaded so that a screw 200 can be fitted thereto.

The frame 4a with above-described configuration is symmetrical about a plane which passes through axis lines of all holes 412 among the planes passing through the closed outer rim of the main frame portion 41. Hence, when the cover members 2 and 3 that are substantially of the same shape are joined by the frame 4a, the cover members 2 and 3 are arranged symmetrically about the frame 4a.

A configuration of the connector 4b will be described. The connector 4b includes a main plate portion 46 and two pressing protruding portions 47. The main plate portion 46 is a flat plate with an octagonal surface. The two pressing protruding portions 47 are provided near respective opposing sides of the octagonal surface of the main plate portion 46, and are projected orthogonal from the surface of the main plate portion 46. The pressing protruding portion 47 has a trigonal pyramidal shape. The two pressing protruding portions 47 are pressed into different cover members. The main plate portion 46 has three holes 48 arranged at equal intervals. The connector 4b can be fixed to the frame 4a by fastening the screws through the holes 48. The holes 48 are arranged in a direction perpendicular to the direction of arrangement of two pressing protruding portions 47 on the surface of the main plate portions 46.

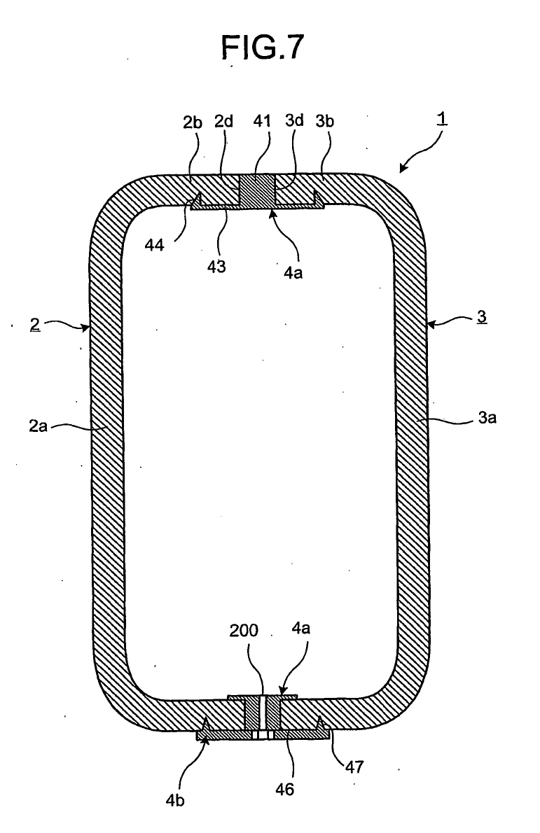

FIG. 7 shows a configuration of a jacket of the digital camera 1. FIG. 7 is a vertical sectional view of the jacket when viewed along a line corresponding to line C-C of FIG. 6. As can be seen from FIG. 7, the protruding portions 44 are buried into the cover members 2 and 3, respectively, from internal surfaces of the side plate portions 2b and 3b. The protruding portions 44 have a function of preventing the cover members 2 and 3 from being detached from the main plate portion 41 (anchoring function).

In FIG. 7, the pair of protruding portions 45 belonging to the same wooden piece anchor 400 as that which the protruding portion 44 pressed into the side plate portion 2b belongs to is pressed into the end face 2d of the cover member 2, symmetrically arranged about the section shown in FIG. 7. The pair of protruding portions 45 has a function of suppressing an excessive deformation of the side plate portion 2b toward an external surface of the side plate portion 2b when the side plate portion 2b is subjected to a force which acts in an outward thickness direction of the side plate portion 2b (upward direction in FIG. 7). On the other hand, in FIG. 7, the pair of protruding portions 45 belonging to the same wooden anchor 400 as that which the protruding portion 44 that is pressed into the side plate portion 3b belongs to is pressed into the end face 3d of the cover member 3, symmetrically arranged about the section shown in FIG. 7. The pair of protruding portions 45 facing the cover member 3 similarly has the function of suppressing the excessive deformation of the cover member 3 by an external force.

The wooden piece anchors 400 that are provided on the short side portions of the main frame portion 41 are attached respectively to the side plate portions 2c and 3c which correspond to side faces of the digital camera 1 in a similar fashion as described above, though not specifically shown. Thus, when all the wooden piece anchors 400 are attached to the cover members 2 or 3, the cover, members 2 and 3 are completely fixed to the frame 4a.

The connector 4b is fixed to the frame 4a by screws 200, and at the same time the pressing protruding portions 47 are pressed into respective external surfaces of the cover members 2 and 3. The pressing protruding portions 47, thus has a function of securely fixing the connector 4b to the cover members 2 and 3 and preventing separation of the end faces 2d and 3d from the contact faces 411 of the frame 4a.

When such connector 4b is provided, the joining member 4 can be detached from the cover members 2 and 3 simply by unfastening the screw 200 and removing the connector 4b from the frame 4a. Hence, the repair and maintenance check of the inside of the digital camera 1 can be readily performed. In addition, since the main plate portion 46 is a flat plate, the digital camera 1 does not wobble when placed on a table, and is suitable for self-timer shooting, for example.

The joining member 4 with above-described configuration is formed from a material which has a significantly higher strength and endurance for bending and tension than a material for the cover members 2 and 3. For example, the joining member 4 is formed from metal, or super engineering plastic represented by polyimide.

The protruding portion 44 may have a tapered shape other than the trigonal pyramid (for example, the shape of the protruding portion 44 may be a circular cone, or any polygonal pyramid). Similarly, the protruding portion 45 and the pressing protruding portion 47 may have a tapered shape other than the circular cone (for example, polygonal pyramid). In addition, the surface of the main plate portion 46 does not need to be octagonal. The numbers of the pressing protruding portions 47 and the holes 48 are also not limited to the numbers in the above described embodiment. In addition, as far as there is one connector 4b, the number of the connectors 4b can be changed as appropriate depending on conditions such as the size of the digital camera 1.

A method of processing the cover members 2 and 3 will be described. In the following, the method of processing the cover member 2 will be described by way of example, and the cover member 3 is processed in the same manner. First, a wooden piece is taken out from uncompressed raw wood by cutting or the like so that the wooden piece has a predetermined three-dimensional shape. The wooden piece thus taken out is larger in volume than a finished wooden piece by an amount to be decreased during a compression process described later. Hereinbelow, thus shaped wooden piece is referred to as wooden piece 51. A portion that is processed into either the main plate portion 2a of the cover member 2 or the main plate portion 3a of the cover member 3 is referred to as main plate portion 51a. A portion that is processed into either the side plate portion 2b (and 2c) of the cover member 2 or the side plate portion 3b (and 3c) of the cover member 3 is referred to as side plate portion 51b (and 51c).

Thereafter, the wooden piece 51 taken out is compressed (compression process). Before the compression process, the wooden piece 51 is left in a water vapor atmosphere of high temperature and high pressure for a predetermined time period, so that the wooden piece 51 excessively absorbs moisture to be softened. Here, the high temperature means 100 to 230° C. and more preferably approximately 180 to 200° C., and the high pressure means 0.1 to 3 MPa (MegaPascal) and more preferably approximately 0.45 to 2.5 MPa. Alternatively, the wooden piece may be heated and softened by application of high-frequency electromagnetic wave such as microwave rather than by being left in the waver vapor atmosphere as described above.

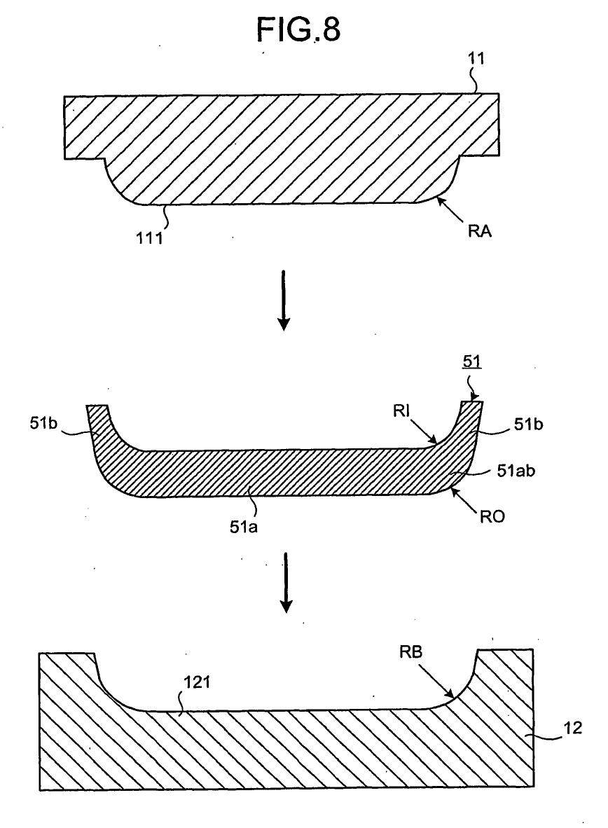

Subsequently, the softened wooden piece 51 is compressed in the same water vapor atmosphere. FIG. 8 schematically shows an outline of the compression process. In FIG. 8, the wooden piece 51, which is taken out from the raw wood as described above, is sandwiched between a pair of metal molds 11 and 12 and compressed. The metal mold 11 which is employed for applying compressive force to the wooden piece 51 from above at the time of compression has a protrusion 111 shaped to fit with the internal surface of the wooden piece 51. When the radius of curvature of an internal surface of a curved portion 51ab extending from the main plate portion 51a to the side plate portion 51b of the wooden piece 51 is represented as RI, and the radius of curvature of a curved surface, which abuts the curved portion 51ab during compression, on the protrusion 111 is represented as RA, relation represented as RI>RA is satisfied.

On the other hand, the metal mold 12 which is employed for applying compressive force to the wooden piece 51 from below has a depression 121 that fits an external surface of the wooden piece 51. When the radius of curvature of an external surface of the curved portion 51ab extending from the main plate portion 51a to the side plate portion 51b of the wooden piece 51 is represented as RO, and the radius of curvature of a curved surface, which abuts the external surface of the curved portion 51ab during compression, on the depression 121 is represented as RB, relation represented as RO>RB is satisfied.

When the metal molds 11 and 12 and the wooden piece 51 are viewed along a section passing through the main plate portion 51a and the side plate portion 51c, the shape of the metal molds 11 and 12 and positional relation among the metal molds 11 and 12 and the wooden piece 51 are similar to those shown in FIG. 8 other than dimension. In addition, the radius of curvature of an internal surface of a curved portion extending from the main plate portion 51a to the side plate portion 51c is larger than the radius of curvature of a curved face of the metal mold 11 that abuts the internal surface. The radius of curvature of an external surface of the curved portion that extends from the main plate portion 51a to the side plate portion 51c is larger than the radius of curvature of a curved surface of the metal mold 12 that abuts the external surface.

In the first embodiment, the metal molds 11 and 12 are formed so that compression rate in the thickness direction is substantially uniform at respective portions of the wooden piece 51 (here, the compression rate means a ratio of decrease in the thickness of the wooden piece by the compression to the thickness of the wooden piece before the compression). Thus, the color tone of the cover member 2 obtained after the compression can be made uniform.

FIG. 9 is a diagram showing that the softened wooden piece 51 placed at a predetermined position is sandwiched and compressed by the metal molds 11 and 12. In FIG. 9, the deformation of the wooden piece 51 into a three-dimensional shape corresponding to a gap between the metal molds 11 and 12 has been nearly completed. After the wooden piece 51 is left in a state shown in FIG. 9 for a predetermined time period, the wooden piece 51 is released from compression as the metal molds 11 and 12 are separated from each other. Then, the water vapor atmosphere of high temperature and high pressure as described above is removed and the wooden piece 51 is dried. Thereafter, the openings 21 and 22, and the cut-out portion 23 are formed by cutting or the like, whereby the cover member 2 shown in FIG. 4 is completed.

As a result of the compression process as described above, the cover member 2 or 3 comes to have a substantially uniform thickness, which is approximately 30 to 50% of the thickness of the wooden piece 51 before the compression process (here, the compression rate is approximately 0.5 to 0.7). Generally, the wooden piece 51 can be compressed to approximately 20% the thickness before the compression (in this case compression rate is approximately 0.8). In the present embodiment, however, the compression of the wooden piece 51 is not performed to such a limit. Hence, the cover member 2 or 3 still contains some space inside. The existence of such space prevents changes in the appearance of the cover member 2 or 3 by the intrusion of the protruding portion 44 or the press fit of the protruding portion 45.

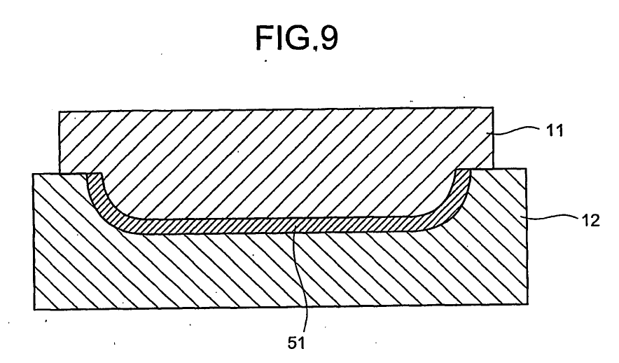

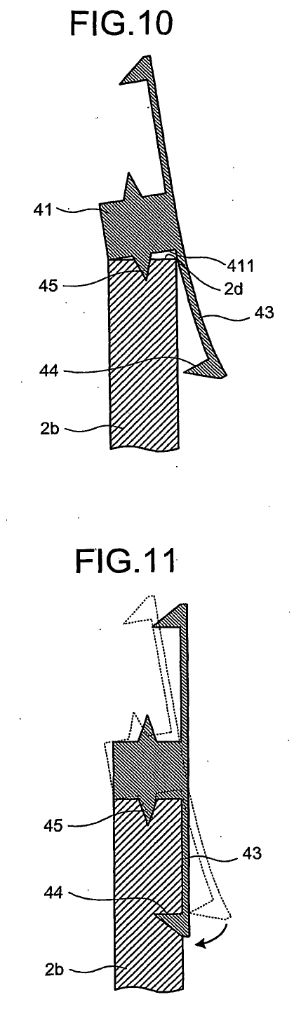

An outline of an attachment process in which the cover members 2 and 3 are attached to the joining member 4 will be described. FIGS. 10 and 11 schematically show how the protruding portion 44 is intruded and the protruding portion 45 is pressed into the cover member 2. FIGS. 10 and 11 show a section along line D-D of FIG. 6. First, the protruding portion 45 is pressed into the end face 2d. In FIG. 10, the apex of the triangular pyramid of the protruding portion 44 has not yet been buried into the side plate portion 2b, and the protruding strip 43 is bending so that the tip end thereof stays away from the side plate portion 2b. In the state shown in FIG. 10, a proximal end portion of the protruding portion 45 has not been completely pressed into the end face 2d, and some portions of the contact face 411 has not yet come into contact with the end face 2d.

Thereafter, the main frame portion 41 is further pressed against the end face 2d and the protruding portion 45 is further pressed into the side plate portion 2b. On the other hand, a portion around the bottom face of the protruding portion 44 is pressed against the side plate portion 2b, and the protruding portion 44 is buried into the internal surface of the side plate portion 2b. Thus, the attachment of the wooden piece anchor 400 to the cover member 2 is completed. Here, the protruding portion 44 and the pair of the protruding portions 45 belonging to the specific wooden piece anchor 400 are focused, and the attachment of these portions to the side plate portion 2b is described. With regard to the joining member 4 having a shape as shown in FIG. 6, for example, a swift attachment of the joining member 4 to the cover member 2 can be realized when the wooden piece anchors 400 are attached to the main frame portion 41 by the side of the rectangle formed by the main frame portion 41.

When the joining member 4 is formed from a hard metal, the protruding strip 43 bends only slightly, and it may not be easy to attach all the wooden piece anchors 400 to the cover member 2 by the same process. In this case, after the wooden piece anchor 400 on one side of the rectangle of the main frame portion 41 is attached to the cover member 2, the wooden piece anchor 400 on the opposing side of the main frame portion 41 may be attached to the cover member 2 while being properly positioned with the use of a suitable jig.

The cover member 3 may be attached to the frame 4a in a similar manner to the attachment process of the cover member 2 described above. As a result, two cover members 2 and 3 come to be joined via the frame 4a at the upper side portion. Needless to say, the joining member 4 can be attached first to the cover member 2 and then to the cover member 3, or vice versa.

After the frame 4a is attached to the two cover members 2 and 3, the connector 4b is fixed to the frame 4a. For the fixation of the connector 4b, the holes 412 of the frame 4a and the corresponding holes 48 of the connector 4b are aligned with each other, and the connector 4b is fixed to the frame 4a by the screws 200. Thus, the digital camera 1 is completed.

In the above described method of forming the joining structure, the cover members 2 and 3 are attached to the joining member 4. As a matter of course, before the attachment process, various functioning units are already housed inside the digital camera 1. That is to say, the internal components of the digital camera 1 are arranged at predetermined positions of the cover members 2 and 3 at an appropriate timing at least before the cover members 2 and 3 are completely fixed to the joining member 4.

In the joining member and the joining structure according to the first embodiment of the present invention as described above, a frame and a connector are provided. The frame abuts respective closed loop end faces of two cover members, and fixes the cover members. The connector can be detachably attached to the frame, and connects the side faces of the cover members with each other. Thus, the joining member can be attached to and detached from the wooden pieces without deterioration of the appearance of the wooden piece.

Further, according to the first embodiment, the compression rate of the wooden piece is controlled so as not to reach the limit value. Hence, even when the wooden piece is thin, the protruding portions that constitute the wooden piece anchor and that are pressed into the wooden piece do not affect the appearance of the side surface of the wooden piece.

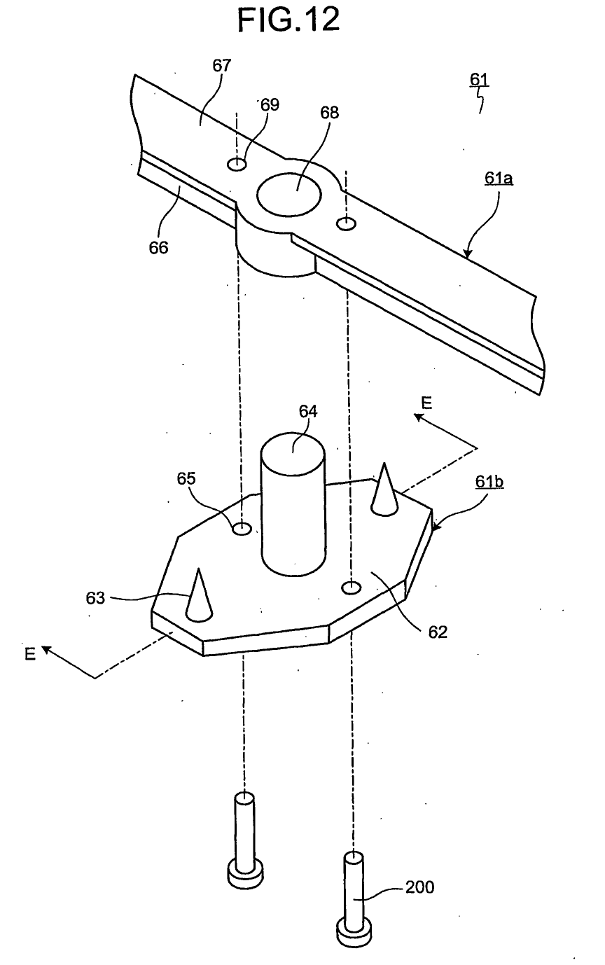

FIG. 12 schematically shows a modification of the joining member of the first embodiment. A joining member 61 of FIG. 12, similarly to the joining member 4 described above, includes a frame 61a and a connector 61b connected to the frame 61a by screws. The connector 61b includes a main plate portion 62, two pressing protruding portions 63, and a threaded cylinder 64 for a tripod. The main plate portion 62 is a flat plate with an octagonal surface. The two pressing protruding portions 63 are provided near respective opposing sides of the octagonal surface of the main plate portion 62, and are projected orthogonal from the surface of the main plate portion 62. The pressing protruding portion 63 has a trigonal pyramidal shape. Two pressing protruding portions 63 are pressed into different cover members. The threaded cylinder 64 is a cylindrical portion which includes a threaded hole running inside. The threaded cylinder 64 is projected cylindrically in a direction perpendicular to the surface of the main plate portion 62 and longer than the pressing protruding portion 63. A screw of the tripod is screwed into the threaded cylinder 64 from the bottom face side, i.e., lower side of FIG. 12. The main plate portion 62 also includes two holes 65 so that the connector 61b can be fixed to the frame 61a by screws. Two holes 65 are arranged at both sides of the threaded cylinder 64. The holes 65 are arranged in a direction perpendicular to the direction in which the pressing protruding portions 63 are arranged on the surface of the main plate portion 62.

The frame 61a which corresponds to the connector 61b having the above-described configuration includes a main frame portion 66 and a guide portion 67 that have similar functions as the main frame portion 41 and the guide portion 42 described above, respectively. Further, the frame 61a includes an opening 68 and holes 69 on a side of the bottom faces of the main frame portion 66 and the guide portion 67. The opening 68 can receive the threaded cylinder 64, and the hole 69 is arranged at a position corresponding to the hole 65 and allows to be screwed. Inner walls of the respective holes 69 are threaded so that the screws 200 can be fixed therethrough. Only one threaded cylinder 64 for a tripod is sufficient for the digital camera. Hence, when two connectors are attached to the frame 61a similarly to the configuration of the joining member 4 described above, one connector may be formed as the connector 61b, and another connector may be formed as the connector 4b. Then, the bottom side of the frame 61a may be configured to have a portion having the configuration of FIG. 12 to which the connector 61b is attached and a portion having the configuration of FIG. 6 in which three holes 412 are formed to which the connector 4b is attached.

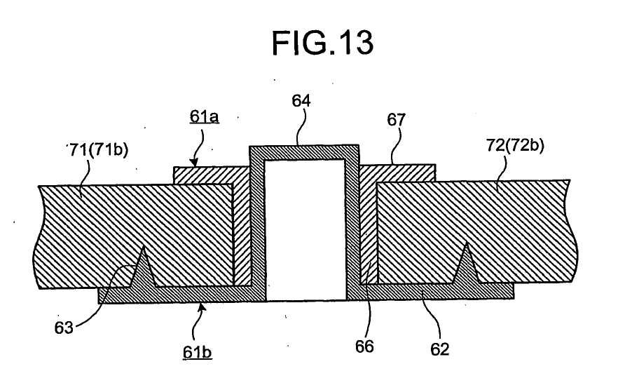

FIG. 13 shows a configuration around a portion where the connector 61b is fixed to the frame 61a in the joining structure realized by the joining member 61. FIG. 13 is a partial vertical sectional view of the joining structure that joins the cover members along a line corresponding to line E-E of FIG. 12. In FIG. 13, a cut-out portion that has a corresponding shape to the outer periphery of the opening 68 of the frame 61a is formed in each of a side plate portion 71b located at a bottom face of a front cover member 71 and a side plate portion 72b located at a bottom face of a rear cover member 72. In other points, the configuration of each of the cover members 71 and 72 is similar to the configuration of each of the cover members 2 and 3, respectively.

The conventional digital camera is provided with a threaded hole so that a tripod can be attached by a screw. Such a hole is fabricated so as to be broken when an excessive external force is applied via the screw in order to prevent damages to a main body of the digital camera. When the threaded hole is integrated with the cover member, replacement of the threaded hole inevitably accompanies replacement of the whole cover member with a new one. In the modification of the first embodiment, the threaded hole for a tripod is integrated with the connector of the joining member. Hence, even when the threaded hole is broken, only the connector in which the threaded hole is formed can be replaced, with the cover member left as it is. As a result, there is no need of replacement of the cover member to which unique texture is added by use.

In the above, a threaded hole is provided in the joining member to allow attachment of a separate member. Alternatively, a strap holder may be provided for an attachment of a strap. When the strap holder is to be formed in the connector, it may be preferable that the connector be arranged at a side face or an upper face of the jacket rather than the bottom face thereof, depending on types of electronic equipment to which the joining member is applied.

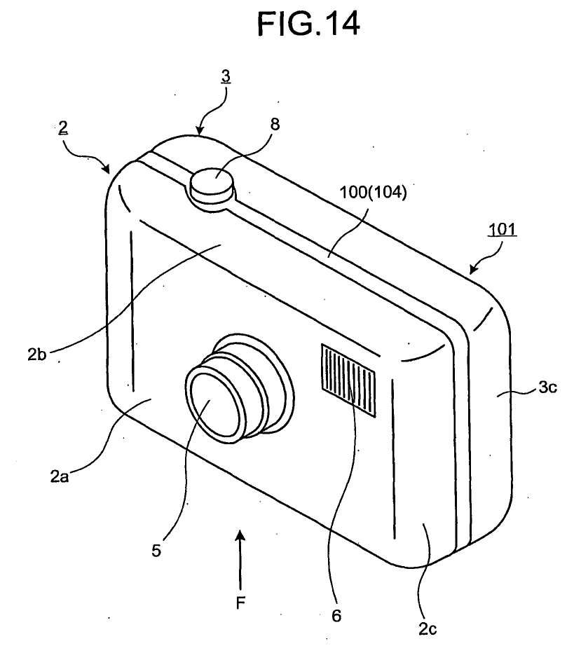

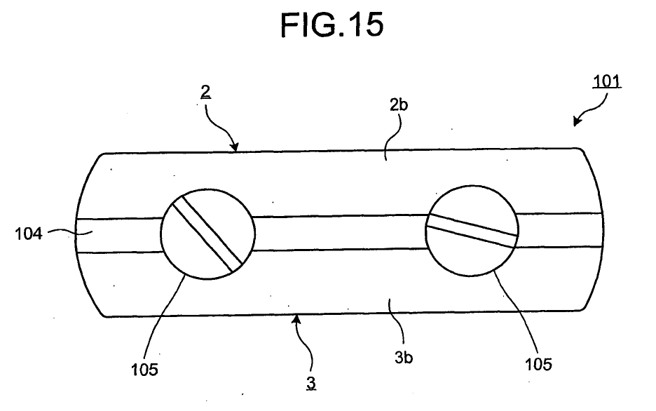

FIG. 14 shows an example of application of a joining member according to a second embodiment of the present invention. Specifically, FIG. 14 is a perspective view of a configuration of a digital camera whose jacket is formed from two wooden pieces joined by the joining member according to the second embodiment. FIG. 15 is a bottom view of the digital camera of FIG. 14 viewed in, the direction of arrow F of FIG. 14. A digital camera 101 shown in FIGS. 14 and 15 includes two cover members 2 and 3 that are substantially of the same shape and a joining member 100 that joins two cover members 2 and 3.

The configuration of each of the cover members 2 and 3 (see FIGS. 4 and 5) and a method of processing the cover member 2 or 3 (see FIGS. 8 and 9) are the same as those of the first embodiment described above. The digital camera 101, similarly to the digital camera 1 described above, includes the image pick-up unit 5, the photoflash 6, and the shutter button 8 (see FIG. 1). Further, the inner configuration of the digital camera 101 (including the display unit 7, the imaging element 9, or the like) is the same as the inner configuration of the digital camera 1 (see FIG. 3).

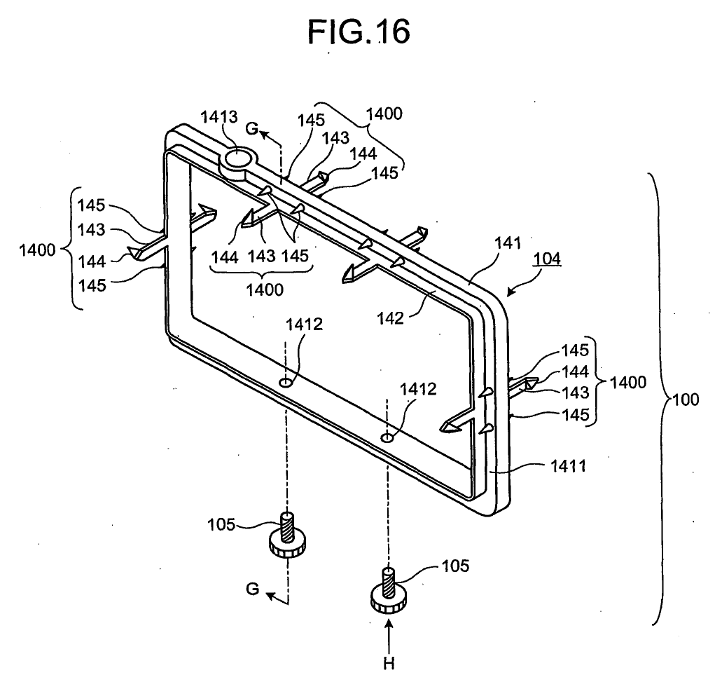

FIG. 16 shows a detailed configuration of the joining member 100. The joining member 100 shown in FIG. 16 is placed between the cover members 2 and 3 to join the cover members 2 and 3. The joining member 100 includes a frame 104 and screws 105. The frame 104 abuts each of the end face 2d of the cover member 2 and the end face 3d of the cover member 3 to fix the cover members 2 and 3. The screw 105 is turned into the frame 104 and has a function of a connector that connects the side plate portion 2b of the cover member 2 and the side plate portion 3b of the cover member 3.

The frame 104 has a main frame portion 141 and a guide portion 142. The main frame portion 141 has a contact face 1411 that abuts the end face 2d of the cover member 2 and the end face 3d of the cover member 3. The guide portion 142 extends from an inner rim of the main frame portion 141 in a direction substantially perpendicular to the contact face 1411 of the main frame portion 141. The guide portion 142 has a function of guiding a movement of each of the cover members 2 and 3 when the cover members 2 and 3 are attached to the frame 104. The frame 104 has a protruding strip 143, a trigonal pyramidal protruding portion 144 (first protruding portion), and two circular conic protruding portions 145 (second protruding portions). The protruding strip 143 protrudes from an edge of the guide portion 142 in a direction perpendicular to the contact face 1411 of the main frame portion 141. The protruding portion 144 protrudes from a tip end portion of the protruding strip 143 towards an outer periphery of the main frame portion 141. Each of the two protruding portions 145 is provided near a proximal end of the protruding strip 143 and protrudes from the contact face 1411 in the direction of protrusion of the guide portion 142. Two protruding portions 145 are arranged symmetrical about a plane perpendicular to the contact face 1411 and passing through the tip end portion of the protruding strip 143 and the apex of the protruding portion 144. Two protruding portions 145 are arranged as a pair.

The protruding strip 143, the protruding portion 144, and a pair of protruding portions 145 each having an above configuration constitute a wooden piece anchor 1400 in combination. The wooden piece anchors 1400 are plurally provided on each contact face 1411 of the frame 104. As shown in FIG. 16, the main frame portion 141 is of a substantially rectangular shape, and has two long sides and two short sides. Each contact face 1411 of the main frame portion 141 includes two sets of wooden piece anchors 1400 on the upper long side (a side on which the shutter button 8 is exposed), and one wooden piece anchor 1400 on each opposite position of two short sides. In brief, each contact face 1411 has four wooden piece anchors 1400. Since the main frame portion 141 has two contact faces 1411, one facing the front side and another facing the rear side, the frame 104 includes eight wooden piece anchors 400 in total.

On the upper side of the main frame portion 141, a cylindrical hollow opening 1413 is formed at a position corresponding to the cut-out portions of the respective cover members so as to expose the shutter button 8. On the lower side of the main frame portion 141, holes 1412 are formed so that the screw 105 can be fixed therethrough. An inner wall of the hole 1412 is threaded so that the screw 105 can be fitted thereto.

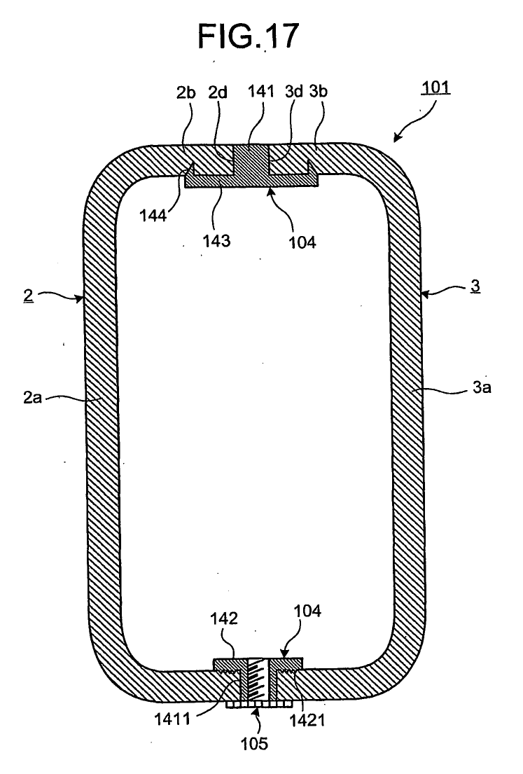

FIG. 17 schematically shows a joining structure including the joining member 100, and is a vertical sectional view taken along a line corresponding to line G-G of FIG. 16. As shown in FIG. 17, the protruding portion 144 is pressed into the internal surfaces of the side plate portions 2b and 3b. The protruding portion 144 has a function of preventing the cover members 2 and 3 from being detached from the main frame portion 141, i.e., anchoring function.

In FIG. 17, a pair of protruding portions 145 belonging to the same wooden piece anchor 1400 as that which the protruding portion 144 pressed into the side plate portion 2b belongs to is pressed into the end face 2d of the cover member 2 symmetrically arranged about the section shown in FIG. 17. The pair of protruding portions 145 has a function of suppressing an excessive deformation of the side plate portion 2b toward external surface when the side plate portion 2b is subjected to a force which acts in an outward thickness direction of the side plate portion 2b (upward direction in FIG. 17). On the other hand, in FIG. 17, the pair of protruding portions 145 belonging to the same wooden piece anchor 1400 as that which the protruding portion 144 that is pressed into the side plate portion 3b belongs to is pressed into the end face 3d of the cover member 3, symmetrically arranged about the section shown in FIG. 17. The pair of protruding portions 145 similarly has the function of suppressing an excessive deformation of the cover member 3 caused by an external force.

The wooden piece anchors 1400 that are provided on short side portions of the main frame portion 141 are attached respectively to the side plate portions 2c and 3c that correspond to the side faces of the digital camera 101 in a similar fashion as described above, though not specifically shown. Thus, when all the wooden piece anchors 1400 are attached to the cover members 2 or 3, the cover members 2 and 3 are completely fixed to the frame 104.

FIG. 18 is a partially enlarged sectional view showing a detailed configuration of a portion near the bottom face shown in FIG. 17. As shown in FIG. 18, the screw 105 which constitutes the joining member 100 together with the frame 104, includes a disk head 151 and a threaded portion 152. The threaded portion 152 extends from a central portion of the head 151 in a direction perpendicular to a surface of the head 151. The threaded portion 152 fits into the hole 1412. The surface from which the threaded portion 152 is projected among the surfaces of the head 151 is partly in contact with the cover members 2 and 3 and perpendicular to the contact face 1411. As is clear from FIGS. 18 and 15, a diameter of the circular head 151 is larger than a gap between the cover members 2 and 3 in (the main frame portion 141 of) the frame 104. Therefore, the cover members 2 and 3 can be securely sandwiched and held in the thickness direction by the head 151 and the guide 142 at a portion near the end faces thereof. Thus, the side plate portion 2b of the cover member 2 can be connected to the side plate portion 3b of the cover member 3, whereby the cover members can be joined.

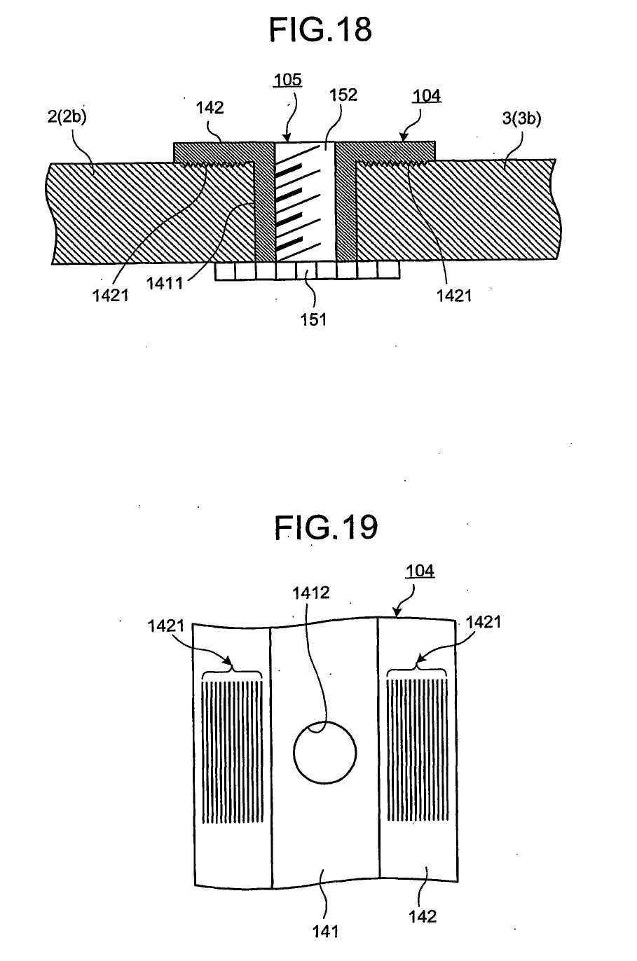

FIG. 19 shows a configuration of the bottom face side of the frame 104. FIG. 19 shows a portion near the hole 1412 viewed in the direction of arrow H of FIG. 16. As shown in FIG. 19, the guide portion 142 has grooves 1421 formed in a direction substantially parallel to a longitudinal direction of the main frame portion 141 on the bottom face (surface that abuts one of the cover members 2 and 3) near the hole 1412 through which the screw 105 is fitted. The grooves 1421 have a function of preventing the end faces 2d and 3d of the cover members 2 and 3 from being separated from the contact face 1411 and preventing the cover members 2 and 3 from falling out from the joining member 100, i.e., anchoring function. The grooves 1421 are formed by straight knurling, for example. The grooves 1421 may be formed like diamond-shaped patterns. The direction of the diamond-shaped patterns may be set so as to intersect with a direction in which the guide 142 extends from the contact face 1411. The grooves 1421 can be formed by criss-cross knurling.

The joining member 100 with the above-described configuration is symmetrical about a plane which passes axis lines of all the holes 1412 among the planes passing through the closed outer rim of the main frame portion 141. Hence, the cover members 2 and 3 that are substantially of the same shape are joined together so as to be located symmetrically about the joining member 100.

When the joining member 100 is to be detached from the cover members 2 and 3, first, the screw 105 is removed, and then the side plate portions 2b and 3b are removed from the frame 104. Thus, the repair and maintenance check of the inside of the digital camera 101 can be readily performed. In addition, since the head 151 is of a disk shape, the digital camera 101 does not wobble when placed on a table, and is suitable for self-timer shooting.

The joining member 100 with the above-described configuration is formed from a material having a significantly higher strength and endurance for bending and tension than a material for the cover members 2 and 3. For example, the joining member 100 is formed from metal or super engineering plastic represented by polyimide.

The protruding portion 144 may be of a tapered shape other than trigonal pyramid (e.g., circular cone, polygonal pyramid, or the like). The protruding portion 145 may similarly be of a tapered shape other than circular cone (e.g., polygonal pyramid, or the like). In addition, the cover members 2 and 3 may be fixed by the screws 105 to the frame 104 at any numbers of positions on the bottom face of the digital camera 101 depending on conditions such as the size of the digital camera 101.

When the cover members 2 and 3 are attached to the joining member 100, the cover members 2 and 3 are first attached to the frame 104 in a similar manner to in the first embodiment (see FIGS. 10 and 11). Needless to say, either of the two cover members 2 and 3 can be attached to the frame 104 first.

After two cover members 2 and 3 are attached to the frame 104, the cover members 2 and 3 are fixed to the frame 104 from the bottom face of the cover members 2 and 3 by the screws 105. Thus, the digital camera 101 is completed.

In the above described method of forming the joining structure, the cover members 2 and 3 are attached to the joining member 100. Needless to say, various functioning units are arranged inside the digital camera 101 at an appropriate stage before the attachment process. That is to say, the internal components of the digital camera 101 are arranged at predetermined positions of the cover members 2 and 3 at an appropriate timing at least before the cover members 2 and 3 are completely fixed to the joining member 100.

In the joining member and the joining structure according to the second embodiment of the present invention as described above, the joining member includes a main frame portion, a guide portion, and a screw. The main frame portion has a contact face which abuts each end face of two cover members (wooden pieces). The guide portion is projected in a direction substantially perpendicular to the contact face of the main frame portion, and guides the movement of the two cover members when the end faces of the cover members are made to abut the contact face. The screw has a flat head and fixed to the main frame portion. The joining member holds the two cover members by sandwiching the cover members between the guide portion and the head, whereby the joining member can be attached to and detached from the wooden piece without deterioration of the appearance of the wooden pieces.

Further, according to the second embodiment, the compression rate of the wooden piece is adjusted so as not to reach the limit value. Therefore, even when thin wooden pieces are to be joined, the appearance of the side surfaces of the wooden pieces is not affected by the protruding portions that constitute the wooden piece anchor and that are pressed into the side surfaces of the wooden piece.

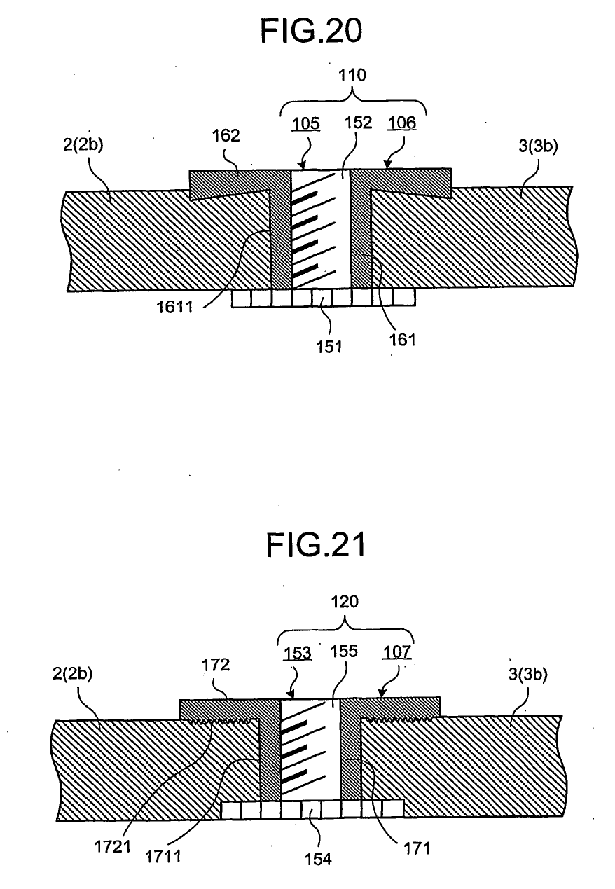

FIG. 20 schematically shows a first modification of the joining structure having the joining member according to the second embodiment. FIG. 20 is a sectional view of a detailed configuration of a portion near a bottom face of a digital camera which has the similar configuration to that of the digital camera 101 (corresponding to FIG. 18). A joining member 110 shown in FIG. 20 includes a frame 106 and a screw 105 which is fitted into the frame 106. The frame 106 is provided with a main frame portion 161 and a guide portion 162. The guide portion 162 extends from the main frame portion 161 in a direction substantially perpendicular to the contact face 1611. Thickness of the guide portion 162 gradually increases outwards from a side of the contact face 1611. Thus the guide portion 162 has a tapered shape. When the screw 105 is fitted into the main frame portion 161, the tapered guide portion 162 gradually bites into the side plate portion 2b of the cover member 2 and the side plate portion 3b of the cover member 3. Thus, the cover members 2 and 3 are fixed to the frame 106. The tapered shape of the guide portion 162 serves to prevent the cover members 2 and 3 from falling out from the frame 106 similarly to the grooves 1421 of the joining member 100. The configuration of the frame 106 is the same as the configuration of the frame 104 if not specified otherwise above.

FIG. 21 schematically shows a second modification of the joining structure having the joining member according to the second embodiment. FIG. 21 is a sectional view of a detailed configuration of a portion near a bottom face of a digital camera which has a similar configuration to that of the digital camera 101 (corresponding to FIG. 18). A joining member 120 shown in FIG. 21 includes a frame 107 and a screw 153. The frame 107 has a main frame portion 171 whose contact face 1711 is depressed inwardly by the amount corresponding to the thickness of a disk-like portion of a head 154 at least at a position where a hole is formed for the attachment of the screw 153. Therefore, when the screw 153 is fitted into the frame 107, the screw 153 is buried into the hole until the bottom surface of the head 154 becomes coplanar with the bottom surfaces of the cover members 2 and 3. The screw 153 is buried into the cover members 2 and 3 in the thickness direction until the upper face of the head 154 abuts an edge of the main frame portion 171. The configuration of the frame 107 is the same as that of the frame 104 if not specified otherwise above. Also in the frame 107, similarly to the frame 104, grooves 1721 that are similar to the grooves 1421 are formed on a face of a guide portion 172 which abuts the cover members 2 and 3.

In the second modification, if the cover members 2 and 3 are formed from a relatively hard wooden piece, edge portions of the cover members 2 and 3 may be cut out in positions that abut the periphery of the head 154, so that the screw 153 can be fitted without depressing the edges of the cover members 2 and 3 by the head 154. In the above described configuration, the head 154 is coplanar with the bottom faces of the cover members 2 and 3. Alternatively, however, the bottom face of the head 154 may smoothly lead to the faces of the cover members while forming a smoothly curved surface, depending on the shape of the cover members.

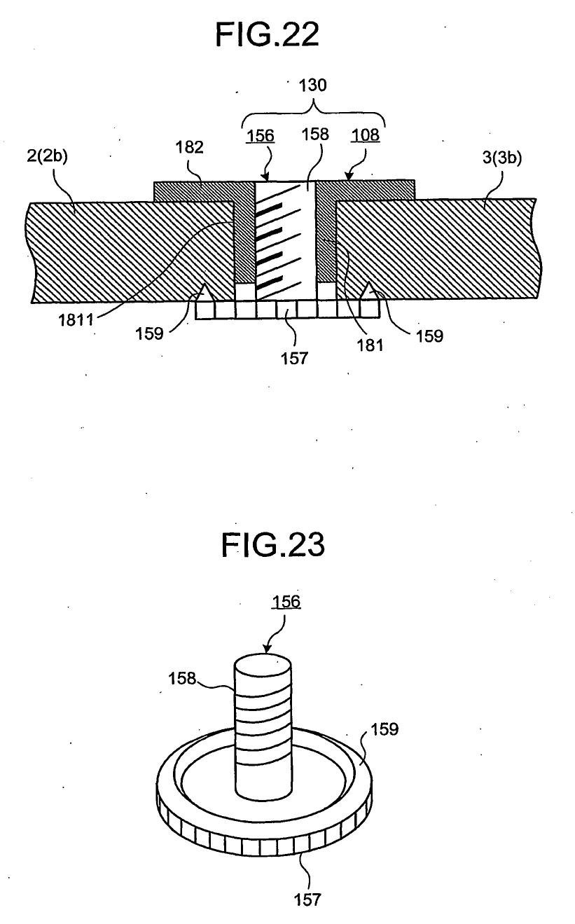

FIG. 22 schematically shows a third modification of the joining structure having the joining member according to the second embodiment. FIG. 22 is a sectional view of a detailed configuration of a portion near a bottom face of a digital camera which has a similar configuration to that of the digital camera 101 (corresponding to FIG. 18). Further, FIG. 23 is a perspective view of a configuration of a screw which is employed in the joining member according to the third modification. A joining member 130 shown in FIGS. 22 and 23 includes a frame 108 and a screw 156 fitted into the frame 108. The screw 156 is provided with a ring flange 159 which forms a closed ring uniform protrusion projected from an outer rim of the surface of the head 157 from which a threaded portion 158 is projected. When the screw 156 is fitted into a main frame portion 181 of the frame 108, the ring flange 159 is pressed into the side plate portions 2b and 3b so that the ring flange 159 serves as an anchor that prevents the cover members 2 and 3 from falling out from the frame 108. Here, a lower end face of the main frame portion 181 is not brought into contact with the head 157 of the screw 156. Such arrangement intends to prevent the ring flange 159 from being caught by the main, frame portion 181 at the fitting of the screw 156 into the main frame portion 181, in order to facilitate the press fitting of the ring flange 159 into the cover members 2 and 3.

A guide portion 182 of the frame 108 extends from a bottom face of the main frame portion 181 in a direction perpendicular to the main frame portion 181, and is not provided with an additional structural element such as the groove 1421 of the frame 104. The configuration of the frame 108 is the same as that of the frame 104 if not specified otherwise.

According to the first to the third modifications of the second embodiment of the present invention, the joining member can be readily attached to and detached from the wooden piece without deteriorating the appearance of the wooden piece similarly to the second embodiment. The above-described second embodiment and its modifications can be appropriately combined in order to realize various modifications of joining member and joining structure of the second embodiment.

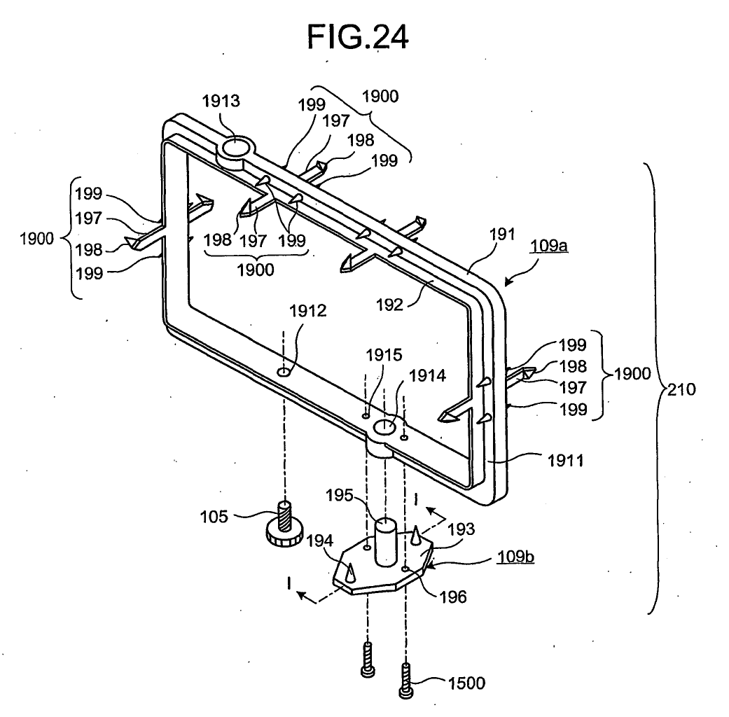

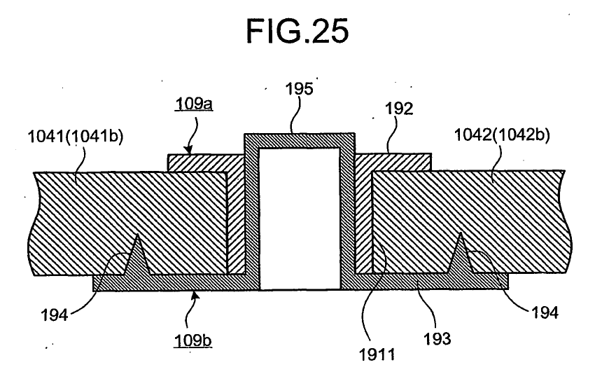

FIG. 24 schematically shows a detailed configuration of a joining member according to a third embodiment of the present invention. FIG. 25 schematically shows a joined state of the cover member and the joining member of the third embodiment at a portion near a bottom face of the cover member. FIG. 25 is a partial vertical sectional view taken along a line corresponding to line I-I of FIG. 24. A joining member 210 shown in FIGS. 24 and 25 is placed between two cover members 1041 and 1042 that cover a digital camera which has the same configuration as that of the digital camera 101 of the second embodiment. The joining member 210 includes a frame 109a, a connector 109b, and a screw 105. The frame 109a abuts an end face of each of the cover members 1041 and 1042. The connector 109b is detachably attached to the frame 109a, and connects a side plate portion 1041b of the cover member 1041 and a side plate portion 1042b of the cover member 1042. The screw 105 has a function as a connector that connects the side plate portion 1041b of the cover member 1041 and the side plate portion 1042b of the cover member 1042 similarly to the connector 109b, though different in shape from the connector 109b. The screw 105 is fitted into the frame 109a.

The connector 109b includes a main plate portion 193, two pressing protruding portions 194, and a threaded cylinder 195 for a tripod. The main plate portion 193 is a flat plate with an octagonal surface. The two pressing protruding portions 194 are provided near respective opposing sides of the octagonal surface of the main plate portion 193 and are projected orthogonal from the surface of the main plate portion 193. The pressing protruding portion 194 has a trigonal pyramidal shape. The two pressing protruding portions 194 are pressed into different cover members. The threaded cylinder 195 is a cylindrical portion which includes a threaded hole running inside. The threaded cylinder 195 is projected cylindrically in a direction perpendicular to the surface of the main plate portion 193 and longer than the pressing protruding portion 194. A screw of the tripod is screwed into the threaded cylinder 195 from the bottom face side, i.e., lower side of FIG. 24. The main plate portion 193 also includes two holes 196 so that the connector 109b can be fixed to the frame 109a by screws. Two holes 196 are arranged at both sides of the threaded cylinder 195. The holes 196 are arranged in a direction perpendicular to the direction in which the pressing protruding portions 194 are arranged on the surface of the main plate portion 193.

The frame 109a which corresponds to the connector 109b having the above-described configuration includes a main frame portion 191 and a guide portion 192 that have similar functions as the main frame portion 141 and the guide portion 142 described above, respectively. Further, the frame 109a includes an opening 1914 and holes 1915 on a side of the bottom faces of the main frame portion 191 and the guide portion 192. The opening 1914 can receive the threaded cylinder 195, and the hole 1915 is arranged at a position corresponding to the hole 196 and allows to be screwed. Inner walls of the respective holes 1915 are threaded so that screws 1500 can be fixed therethrough. Here, only one threaded cylinder 195 is sufficient for a digital camera. Hence, on the bottom face of the guide portion 192, a hole 1912 which is similar to the hole 1412 formed on the guide portion 142 of the second embodiment is provided. The screw 105 is fitted into the hole 1912. Here, if the thicknesses of the main plate portion 193 of the connector 109b and the thickness of the head 151 of the screw 105 are made equal, the bottom face of the digital camera becomes more flat and the digital camera can be more stably placed on a table, for example.

Further, the frame 109a has a protruding strip 197 that protrudes from an edge of the guide portion 192 in a direction perpendicular to the contact face 1911 of the main frame portion 191, a trigonal pyramidal protruding portion 198 (first protruding portion) that protrudes from a tip end portion of the protruding strip 197 towards an outer periphery of the main frame portion 191, and two circular conic protruding portions 199 (second protruding portions) each of which is provided near a proximal end of the protruding strip 197, and protrudes from the contact face 1911 in the direction of protrusion of the guide portion 192. Two protruding portions 199 are arranged symmetrical about a plane perpendicular to the contact face 1911 and passing through the tip end portion of the protruding strip 197 and the apex of the protruding portion 198. Two protruding portions 199 are arranged as a pair. The protruding strip 197, the protruding portion 198, and the pair of the protruding portions 199 constitute a wooden piece anchor 1900 similarly to the first and the second embodiments (in FIG. 24, eight wooden piece anchors 1900 are formed in total).

As shown in FIG. 25, the side plate portion 1041b of the front cover member 1041 and the side plate portion 1042b of the rear cover member 1042a are partially cut out at the bottom face so that an outer periphery of a portion surrounding the opening 1914 of the frame 109a can be made to fit therewith. In other points, the configuration of the cover members 1041 and 1042 is the same as that of the cover members 2 and 3.

Thus, similarly to the first and the second embodiment, according to the third embodiment of the present invention as described above there is provided a joining member and a joining structure which a wooden piece can be readily attached to and detached from without deterioration in the appearance of the wooden piece.

Further, according to the third embodiment, the threaded hole for a tripod is integrated with the connector of the joining member. Hence, even when the threaded hole is broken, only the connector in which the threaded hole is formed can be replaced, with the cover member left as it is. As a result, there is no need of replacement of the cover member to which unique texture is added by use.

Similarly to the second modification of the second embodiment, the bottom face of the main plate portion 193 of the connector 109b may be formed to be coplanar with the bottom face of the cover member 1041 or the bottom face of the cover member 1042.

Still further, in the above, a threaded hole is provided in the joining member to allow attachment of a separate member. Alternatively, a strap holder may be provided for an attachment of a strap. When the strap holder is to be formed in the connector, it may be preferable that the connector be arranged at a side face or an upper face of the jacket rather than the bottom face thereof, depending on types of electronic equipment to which the joining member is applied.

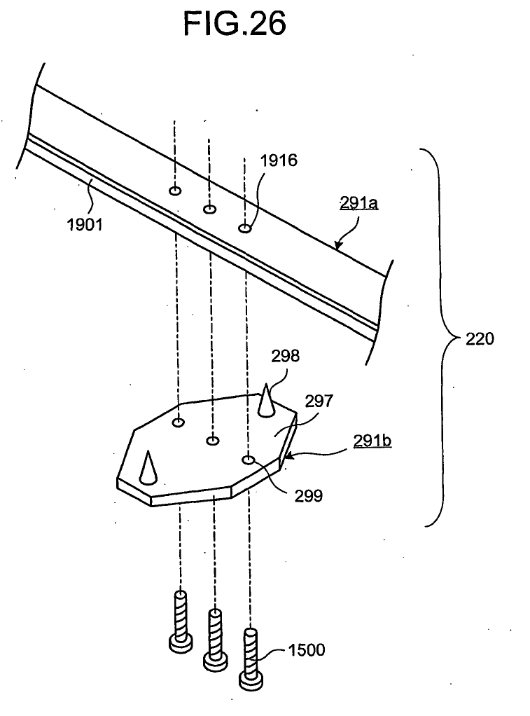

FIG. 26 shows a configuration of relevant parts in a modification of the joining member according to the third embodiment. A joining member 220 shown in FIG. 26 includes a frame 291a, a connector 291b that is detachably attached to the frame 291a to connect two cover members (not shown), and screws 1500 that are fitted to the frame 291a. The connector 291b includes a main plate portion 297 and two pressing protruding portions 298. The main plate portion 297 is a flat plate with an octagonal surface. Two pressing protruding portions 298 are provided near respective opposing sides of the octagonal surface of the main plate portion 297 and are projected orthogonal from the surface of the main plate portion 297 in a trigonal pyramidal shape. The pressing protruding portion 298 are pressed into different cover members. The main plate portion 297 has three holes 299 arranged at equal intervals. The connector 291b can be fixed to the frame 291a by fastening the screws 1500 through the holes 299. The holes 299 are aligned in a direction perpendicular to the direction of arrangement of the pressing protruding portions 298.

A main frame portion 1901 of the frame 291a, to which the connector 291b with the above-described configuration is fixed, has three holes 1916 at a bottom face thereof arranged at equal intervals. The connector 291b can be fixed to the frame 291a by inserting the screws 1500 into the holes 1916. Inner walls of the holes 1916 are threaded so as to fit with the screws 1500. In other points than those described above, the frame 291a has the same configuration as that of the frame 109a.

In the third embodiment described above, the connector has the threaded cylinder for a tripod. In general, however, the connector may not always have the threaded cylinder for a tripod. The joining member 220 according to the modification of the third embodiment is suitable for the configuration of a jacket of an electronic equipment which does not need the threaded cylinder for a tripod.

In the third embodiment, the surfaces of the main plate portion 193 of the connector 109b and the main plate portion 297 of the connector 291b are octagonal. The octagonal shape in the third embodiment, however, is merely described by way of example. Needless to say, the shape of the connector can be changed depending on the shape of the cover member or the like.

In the above, the exemplary embodiments of the present invention are described in detail as the first to the third embodiments. It should be noted, however, that the present invention is not limited to the three embodiments described above. For example, the number of wooden pieces to be joined by the joining member can be three or more.

Further, though the wooden piece anchor is provided on the upper face and the side face of the main plate portion to secure the cover members in the above embodiments, the cover members may be fixed on the upper face and the side face of the main plate portion similarly to the bottom face of the main plate portion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### INDUSTRIAL APPLICABILITY

The present invention is suitable for a jacket for small portable electronic equipments such as digital camera, portable telephone, portable communication terminal such as Personal Handyphone System (PHS) and Personal Digital Assistant (PDA), portable audio device to which audio recording medium such as MiniDisc® (MD), Compact Disc (CD), Digital Versatile Disk (DVD); or cartridge tape is attached for sound output, IC recorder, portable television set, portable radio set, remote control for various home appliances, and digital video player/recorder. Further, the present invention can be applied to a compressed wood product other than the jacket for electronic equipments.

1. A joining member (4; 61; 100; 110; 120; 130; 210; 220) that is placed between plural wooden pieces (2, 3; 71, 72; 1041, 1042) to join the plural wooden pieces (2, 3; 71, 72; 1041, 1042), comprising:
a frame (4a; 61a; 104; 106; 107; 108; 109a; 291a) that abuts an end face (2d, 3d) of each of the plural wooden pieces (2, 3; 71, 72; 1041, 1042) to fix the plural wooden pieces (2, 3; 71, 72; 1041, 1042); and
a connector (4b; 61b; 105; 153; 156; 109b; 291b) that is detachably attached to the frame (4a; 61a; 104; 106; 107; 108; 109a; 291a) to connect at least two wooden pieces (2, 3; 71, 72; 1041, 1042) among the plural wooden pieces (2, 3; 71, 72; 1041, 1042).

2. The joining member (4; 61; 100; 110; 120; 130; 210; 220) according to claim 1, wherein
the frame (4a; 61a; 104; 106; 107; 108; 109a; 291a) includes
a main frame portion (41; 66; 141; 161; 171; 181; 191; 1901) that has a contact face (411; 1411; 1611; 1711; 1811; 1911) which abuts the end face (2d, 3d) of each of the plural wooden pieces (2, 3; 71, 72; 1041, 1042), and
a guide portion (42; 67; 142; 162; 172; 182; 192) that extends in a direction substantially perpendicular to the contact face (411; 1411; 1611; 1711; 1811; 1911) of the main frame portion (41; 66; 141; 161; 171; 181; 191; 1901) to guide a moving direction of each of the plural wooden pieces (2, 3; 71, 72; 1041, 1042) when the end face (2d, 3d) of each of the plural wooden pieces (2, 3; 71, 72; 1041, 1042) is made to abut the contact face (411; 1411; 1611; 1711; 1811; 1911).

3. The joining member (4; 61; 210; 220) according to claim 1 or 2, wherein
the connector (4b; 61b; 109b; 291b) includes
a flat main plate portion (46; 62; 193; 297), and
at least two pressing protruding portions (47; 63; 194; 298) each projected in a tapered shape from one surface of the main plate portion (46; 62; 193; 297) in a direction substantially orthogonal to the one surface of the main plate portion, the pressing protruding portions being pressed into respective surfaces of different wooden pieces among the plural wooden pieces.

4. The joining member (4; 61; 210; 220) according to any one of claims 1 to 3, wherein
the connector (4b; 61b; 109b; 291b) is fixed to the frame (4a; 61a; 109a; 291a) by a screw (200, 1500).

5. The joining member (100; 110; 120; 130) according to any one of claims 1 to 4; wherein
the connector (105; 153; 156) includes a screw (105; 153; 156) which has a plate head (151; 154; 157) and is fitted into the main frame portion (141; 161; 171; 181), and
the plural wooden pieces (2, 3) are sandwiched between the guide portion (142; 162; 172; 182) and the head (151; 154; 157).

6. The joining member (100; 110; 120; 130) according to claim 5, wherein
a maximum diameter of a surface of the head (151; 154; 157) is larger than a width of a portion of the main frame portion (141; 161; 171; 181) placed between different wooden pieces (2, 3).

7. The joining member (100; 110; 120; 130) according to claim 5 or 6, wherein
the surface of the head (151; 154; 157) is substantially perpendicular to the contact face (1411; 1611; 1711; 1811) when the screw (105; 153; 156) is fitted into the main frame portion (141; 161; 171; 181).

8. The joining member (100; 120) according to any one of claims 5 to 7, wherein
the guide portion (142; 172) has grooves (1421; 1721) that are oriented toward a direction intersecting with a direction in which the guide portion (142; 172) extends from the contact face (1411; 1711) of the main frame portion (141; 171) on a surface which abuts one of the plural wooden pieces (2, 3) near a position where the screw (105; 153) is fitted into the main frame portion (141; 171).

9. The joining member (110) according to any one of claims 5 to 8, wherein
the guide portion (162) is tapered so that a thickness thereof increases as a position on the guide portion (162) is far from the contact face (1611) of the main frame portion (161).

10. The joining member (130) according to any one of claims 5 to 9, wherein
the head (157) has a disk shape and is provided with a ring flange (159) which forms a closed ring uniform protrusion projected from an outer rim of the one surface of the head (157), the one surface facing the guide portion (182).

11. The joining member (120) according to any one of claims 5 to 10, wherein
a surface of the head (154) that does not face with the guide portion (172) and a surface of at least one of the wooden pieces (2, 3) sandwiched between the head (154) and the guide portion (172) together form an identical plane, or a smooth curved surface.

12. The joining member (4; 100; 210) according to any one of claims 2 to 11, wherein
the frame (4a; 104; 109a) includes
a protruding strip (43; 143; 197) that protrudes from an edge of an inner periphery of the main frame portion (41; 141; 191) in a direction substantially perpendicular to the contact face (411; 1411; 1911),
a first protruding portion (44; 144; 198) that protrudes in a tapered shape from a tip end portion of the protruding strip (43; 143; 197) towards an outer periphery of the main frame portion (41; 141; 191), and
a pair of second protruding portions (45; 145; 199) each protruding in a tapered shape from the contact face (411; 1411; 1911) near a proximal end of the protruding strip (43; 143; 197) in a direction substantially perpendicular to the contact face (411; 1411; 1911) and in a direction of protrusion of the protruding strip (43; 143; 197) as well, and being arranged symmetrical about a plane perpendicular to the contact face (411; 1411; 1911) and passing through the tip end portion of the protruding strip (43; 143; 197) and the apex of the first protruding portion (44; 144; 198).

13. The joining member (4; 100; 210) according to claim 12, wherein
the frame (4a; 104; 109a) includes
plural wooden piece anchors (400; 1400; 1900) each of which is a combination, of the protruding strip (43; 143; 197), the first protruding portion (44; 144; 198), and the pair of the second protruding portions (45; 145; 199), and
the frame (4a; 104; 109a) is symmetrical about a plane passing through the main frame portion (41; 141; 191).

14. The joining member (4; 100; 210) according to claim 13, wherein
in the wooden piece anchor (400; 1400; 1900), an apex of the first protruding portion (44; 144; 198) is arranged at a same distance from apexes of one of the second protruding portions (45; 145; 199).

15. The joining member (4; 100; 210) according to any one of claims 2 to 14, wherein
the main frame portion (41; 141; 191) has a closed shape.

16. The joining member (61; 210) according to any one of claims 1 to 11, wherein
the connector (61b, 109b) has an attachment unit (64; 195) for attachment of a separate member.

17. The joining member (61; 210) according to claim 16, wherein
the attachment unit (64; 195) has a threaded hole where a screw of a tripod is fitted.

18. A joining structure comprising:
the plural wooden pieces (2, 3; 71, 72; 1041, 1042); and
the joining member (4; 61; 100; 110; 120; 130; 210; 220), according to any one of claims 1 to 17.

19. The joining structure according to claim 18, wherein
the plural wooden pieces (2, 3; 71, 72; 1041, 1042) are formed through compression.

20. The joining structure according to claim 18 or 19, wherein
the plural wooden pieces (2, 3; 71, 72; 1041, 1042) each has a closed loop end face (2d, 3d).

21. The joining structure according to any one of claims 18 to 20, wherein
the joining member (4; 61; 100; 110; 120; 130; 210; 220) is formed from a material with a higher strength than a material for the plural wooden pieces (2, 3; 71, 72; 1041, 1042).

22. The joining structure according to any one of claims 18 to 21, wherein
the plural wooden pieces (2, 3) and the joining member (4; 100) form a jacket for an electronic equipment (1; 101).
